(19) United States
(12) Patent Application Publication
(10) Pub. No.: US 2005/0047988 A1
(43) Pub. Date: Mar. 3, 2005

(54) Method of making hydrocyanic acid using a mass spectrometer control system

(76) Inventor: Tae Hoon Kim, Orange, TX (US)

Correspondence Address: E I DU PONT DE NEMOURS AND COMPANY;LEGAL PATENT RECORDS CENTER, BARLEY MILL PLAZA 25/1128, 4417 LANCASTER PIKE, WILMINGTON, DE, 19805, US

(21) Appl. No.: 10/653,817

(22) Filed: Sep. 3, 2003

(51) Int. Cl. C01C 3/02

(52) U.S. Cl. 423/376

(57) ABSTRACT

A method for making hydrocyanic acid in which the product of the reaction of methane and ammonia is analyzed using a mass spectrometer whose output is used to control the feed ratios of methane and ammonia to the reactor to control product quality.

### FIELD OF THE INVENTION

This invention relates to the field of producing hydrocyanic acid by reacting ammonia with natural gas and an oxygen-containing gas at an elevated temperature in the presence of a suitable catalyst and monitoring the reaction using a mass spectrometer control system the data from which can be used to control the reaction conditions.

### BACKGROUND OF THE INVENTION

Hydrocyanic acid (or “hydrogen cyanide”) (HCN) can be commercially produced by reacting ammonia with natural gas (methane) and an oxygen-containing gas (air) at an elevated temperature in a converter in the presence of a suitable catalyst, as shown below:
NH₃+CH₄+1.5O₂→HCN+3H₂O.

It is well known that a wide range of minor reactions involving unreacted methane takes place in presence of the catalyst in this process. Some of these reactions lead to the formation of saturated or unsaturated C₂-C₅ nitrile compounds, e.g. acetonitrile, acrylonitrile, propionitrile, etc. For example, unreacted methane in the above process reacts with HCN to form acetonitrile:
CH₄+HCN→CH₃CN+H₂.

Also, it is believed that unreacted methane in the above process causes the formation of several other nitrile compounds through the following reactions:
2CH₄→C₂H₄+2H₂ and
C₂H₄+HCN→C₂H₅CN→C₂H₃CN+H₂.

These nitrile compounds (by-products) can lead to significant problems in plant operation. Hydrolysis of the above nitrile compounds produces acid salts that are believed to contribute to foaming in distillation equipment that may be involved in a so-called ammonia recovery train. The nitrile compounds tend to accumulate at the base of an HCN enricher column and at the head of an HCN stripper column in an HCN refining train. The high nitrile concentrations that build up in the involved columns can lead to unstable operation of the columns that results in off-quality HCN and high HCN in the waste stream. While the HCN enricher tails stream might be continuously or intermittently purged to a waste gas header in order to avoid process upsets, such activity may result in high HCN loss.

It is known that the concentration of these undesirable nitrile compounds is a function of the concentration of unreacted methane in the product gas stream (often called methane leakage). Operating the reactor in a way that minimizes the methane leakage can minimize the concentration of these undesirable nitrile compounds. In general, adjusting the ratio of flow rates of natural gas and air when the concentrations of methane or one or more of the nitrile compounds exceed their predetermined (tolerable) limit can minimize the concentrations of the undesirable nitrile compounds.

It is known that the concentrations of methane and the nitrile compounds described above can be determined by analytical techniques such as gas chromatographic methods. Adjusting the ratio of flow rates of natural gas and air as a function of the concentrations of methane or one or more of the undesirable nitrile compounds by measuring the concentrations of methane or one or more of the nitrile compounds using a gas chromatograph may be a way to avoid the above-mentioned problems. However, the long analysis time required by the gas chromatographic method does not make the control system very effective. It would, therefore, be desirable to have a control system based on measurement system that requires very short time (e.g. 5-10 seconds) for analysis.

The present invention provides such a control system. In the present invention, a mass spectrometer is employed to measure the concentration of methane or one or more of the nitrile compounds. Typical response time for this analysis by mass spectrometer is about 6 seconds. This allows the use of a mass spectrometer as an on-line instrument to provide information for an effective control system.

### SUMMARY OF THE INVENTION

The present invention is, therefore, a continuous method for making HCN over a predetermined time period, comprising:
(1) feeding air, natural gas and ammonia to a reactor that contains a catalyst comprising a platinum group metal to produce a product gas that comprises HCN, methane and one or more saturated or unsaturated C₂-C₅ nitrile compounds, the natural gas and air being fed to the reactor at a preselected ratio;
(2) withdrawing a sample of the product gas and introducing it into a mass spectrometer to measure in less than 10 seconds the amount of at least one compound from the group consisting of methane and saturated or unsaturated C₂-C₅ nitrile compounds, in the sample;
(3) determining whether the amount of at least one compound measured in step (2) exceeds a predetermined acceptable limit therefor, and, if so:
(4) changing the ratio of natural gas and air to a ratio different from the preselected ratio;
(5) withdrawing a new sample of the product gas and introducing it into the mass spectrometer to measure in the new sample in less than 10 seconds the amount of at least one compound measured in step (2); and
(6) optionally repeating, steps (1) to (5) until the amount of at least one of the compounds selected for measurements in steps (2) and (5) in the sample is below its predetermined acceptable limit; and
(7) repeating steps (1) to (6) over the entire predetermined time period.

### DESCRIPTION OF THE DRAWING

The Drawing consists of one figure, depicting a block diagram of a process embodying the present invention.

### DETAILED DESCRIPTION OF THE INVENTION

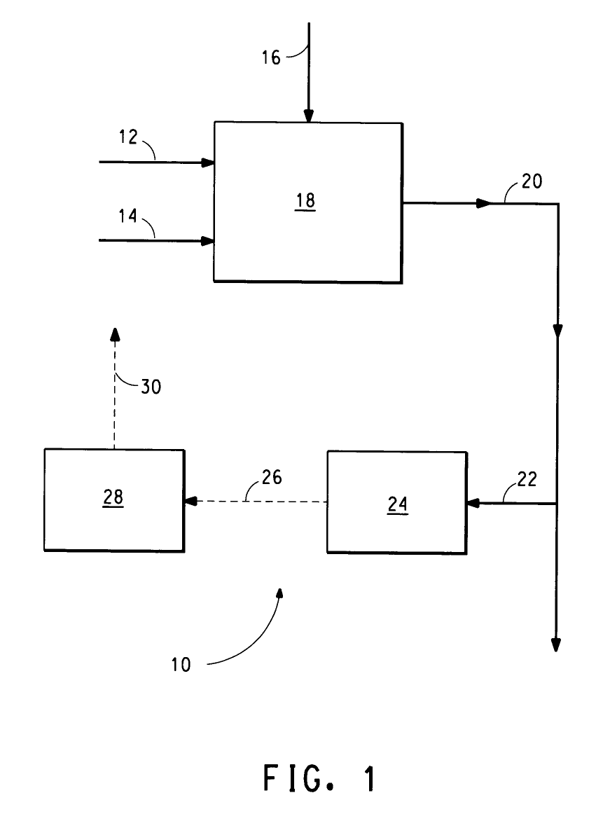

Referring now to FIG. 1, there is shown a block diagram illustrating apparatus 10 that embodies the present invention.

Gaseous streams of air (12), natural gas (14) and ammonia (16) at measured flow rates and at a predetermined ratio of the natural gas and air flow rates are continuously fed to an HCN converter (18).

The HCN converter (18) is a reaction vessel maintained at an elevated temperature typically in the range of 500-1000 deg C. The HCN converter generally contains a suitable catalyst, typically platinum or platinum, containing small amount of another metal of the platinum group (e.g. rhodium). The product gas (20) from the HCN converter comprising HCN and methane is continuously removed. A small portion of the product gas is continually withdrawn (22) and is introduced into a mass spectrometer (24).

The mass spectrometer (24) is an instrument for chemical analysis that can analyze in a very short time for small concentrations of methane and C₂-C₅ nitrile compounds in a gaseous stream comprising HCN and methane. The analysis time is typically about 6 seconds. The signal (26) of the concentrations of methane and C₂-C₅ nitrile compounds, as determined by the mass spectrometer, is then transmitted to a control system (28).

The control system (28) can be, in its simplest form, a human operator who reads the signal (26) from the mass spectrometer and determines if the above-determined concentrations of methane and C₂-C₅ nitrile compounds exceed their predetermined acceptable limits. If so, the operator changes the ratio of natural gas (12) and air (14) flow rates to a ratio different from the predetermined ratio.

The control system (28) can also be a computerized automatic control system that reads the signal (26) and determines if the above-determined concentrations of methane and/or C₂-C₅ nitrile compounds exceed their predetermined acceptable limit. If so, the control system sends a signal (30) to the flow-control devices for natural gas and air (not shown) to change the flow rates in a way that the new ratio of the flow rates of natural gas and air is different from the previously selected ratio or the predetermined ratio.

1. A continuous method for making HCN over a predetermined time period, comprising:
(1) feeding air, natural gas and ammonia to a reactor that contains a catalyst comprising a platinum group metal to produce a product gas that comprises HCN, methane and one or more saturated or unsaturated C₂-C₅ nitrile compounds, the natural gas and air being fed to the reactor at a preselected ratio;
(2) withdrawing a sample of the product gas and introducing it into a mass spectrometer to measure in less than 10 seconds the amount of at least one compound selected from the group consisting of methane and saturated or unsaturated C₂-C₅ nitrile compounds, in the sample;
(3) determining whether the amount of the at least one compound measured in step (2) exceeds a predetermined acceptable limit therefor, and, if so:
(4) changing the ratio of natural gas and air to a ratio different from the preselected ratio;
(5) withdrawing a new sample of the product gas and introducing it into the mass spectrometer to measure in the new sample in less than 10 seconds the amount of the at least one compound measured in step (2); and
6) optionally repeating steps (1) to (5) until the amount of at least one of the compounds selected for measurement in steps (2) and (5) in the sample is below its predetermined acceptable limit; and
(7) repeating steps (1) to (6) over the entire predetermined time period.

2. A method as in claim 1 wherein the time for measurement using mass spectrometer in steps (2) and (5) is less than 6 seconds.
